(19) United States
(12) Patent Application Publication
(10) Pub. No.: US 2007/0256005 A1
(43) Pub. Date: Nov. 1, 2007

(54) Field-link autofill

(75) Inventors: James E. Schneider, Lincoln, NE (US); Clay D. Stevens, Lincoln, NE (US); Cameron Colby Thomson, Lake Lotawana, MO (US)

Correspondence Address: Allied Strategy, 324 S 9th St Ste 6, Lincoln, NE, 68508, US

(73) Assignee: Allied Strategy, LLC, Lincoln, NE (US)

(21) Appl. No.: 11/380,346

(22) Filed: Apr. 26, 2006

(51) Int. Cl. G06F 17/00

(52) U.S. Cl. 715/507; 715/505; 715/508

(57) ABSTRACT

The invention provides a method for electronic form filling that enables users to enter data into one source form and have that data transferred into any number of electronic target forms. As the fields are linked through the invention, complete accuracy is provided for any single-entry multiple-target form interactions. The invention works regardless of data standards adoption; does not require target forms to ‘opt-in’; does not store any sensitive, private user information; and is not limited by the state-of-the-art in artificial-intelligence research.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

A. Field of the Invention

The invention relates to a new technique for automating the filling of form data, typically in the context of electronically automated forms. Specifically, the invention described herein was conceived in the pursuit of an economical means to automate the submission of service applications through the internet web-sites of various providers of similar services.

Much of the description of the invention follows the analysis of this situation from the web-form-fill perspective. This is because it is a relatively complete example of how application submission automation systems remain incomplete, due, at least in part, to their lack of compliance with relevant machine-to-machine interface standards.

B. Contextual Scenarios

It is easy to imagine scenarios in which potential service consumers would desire to submit an application to multiple providers of a service or class of services. One source of this desire is that any application process will include various terms of service provision, and the specific arrangements of these terms will have various degrees of desirability. Service consumers benefit from the ability to choose from a larger number of providers in order to optimize their choice for maximum desirability. For example, an individual applying for insurance coverage is likely to desire rate quotes from multiple insurance providers on policies with similar coverage in order to compare their rates and choose the provider with the lowest rate or with the best coverage-to-rate value.

As opposed to situations where a consumer is in a position to choose freely from several providers, some application processes hinge on the evaluation by the provider of the consumer or applicant. This is often the case when applying for acceptance to an academic institution or when applying for employment. In these cases, it may be advantageous for the applicant to submit an application to as many providers as possible to increase the likelihood that at least one will accept the application on favorable terms.

C. The Need:

When a potential service consumer applies for service from several providers, the consumer is required to enter relevant information into each provider's web-site. Because each application is for a similar or related service, most of the articles of information or data are repeated, once for each provider's web-site. Instances of repetition represent lost time and limit the number of applications that it is practical to submit to different service providers.

D. Existing Tools:

Our culture is still adapting to the presence of powerful and continually improving automated information processing technology. Over time, these technologies are being absorbed into existing institutions, creating new institutions, and otherwise changing our intellectual landscape. During this time, many intermediate solutions to information management problems have been, and will be, conceived and implemented. These steps take us progressively toward a more-seamless integration of information technology with our lives.

What follows are a few examples of some existing intermediate solutions to form-entry problems.

D.1. Interface Standards:

In Theory:

Electronic application forms available on providers' web-sites consistently present the same fields (requiring the same data) as other providers because all providers of a given service must answer many of the same questions about their applicants in the process of formulating replies to applications.

Because service provision typically has an underlying structure that demands a particular input datum set, ubiquitous application fields can be standardized on a service-by-service basis. Associations of service providers or third party organizations can survey application processes in order to assemble and maintain lists of application fields and publish them for use by those who design and implement machine-to-machine interfaces. With standard interfaces, it is trivial to build automated information systems that store and retrieve application data and subsequently formulate complete applications, or requests to service providers.

In Practice:

Many information technology professionals recognize that standard interfaces are a significant piece of a complete solution to many general information management problems. For this reason, many organizations have been chartered with the goal of creating useful standards. Sometimes, more than one standards organization exists for the same subset of information-processing machine-interface problems. In these cases, more than one incompatible standard may be published, causing confusion among technology implementers.

Even when there is exactly one set of standards available for a machine-interface problem, there may be difficulties. For example, technology implementers may not be aware of the standard. Also, implementers may not be willing to adopt a standard. This could happen for several reasons. It may be difficult to implement because of complicated relationships between its parts. It may include a great deal of superfluous information that renders the interface inefficient for transmission of the relevant information. It may not standardize enough fields to be useful in practical situations. It may be detrimental to the service provider to adopt the standard simply because that adoption in the service application arena would lead to price-based competition with its competitors.

Many standardized interfaces encounter difficulties like these. These difficulties may have several effects. One effect is that the interface standard remains unused indefinitely. Another effect is that various implementers may choose to modify or extend the standard in proprietary ways. This can cause a single standard to behave as many standards or as no standard at all, reducing or eliminating its effectiveness.

While the future of information technology as a whole may indeed rely on the development of interface standards, there is an ongoing need for some ability to interact between similar information systems utilizing proprietary, differing, or no interface standards. All that is required for this invention to provide value is for service providers to present an application as an HTML (hyper-text markup language) web-form (available on the internet over HTTP or ‘hyper-text transfer protocol’). As we wait for the development of industry-wide, nation-wide, or world-wide interface standards, this invention provides a means of automated interaction in the area of electronic forms regardless of interface standards adoption.

D.2. Centralized Third-Party Databases:

In Theory:

For a given consumer of services, there tends to be a tightly scoped datum set that can fill fields on applications for services from providers specializing in different service types. An association of service providers or a third-party organization can offer to retain the personal data of various users in order to provide it (over some interface standard) to other service providers when some explicit or implicit request is made by the user to do so. If many service providers were capable of receiving the personal data of their consumers this way, then many service consumers may benefit from the additional cost of establishing and maintaining an account with the third-party database.

In Practice:

Centralized database services can help streamline application processes of all kinds. Also, they can serve in many contexts to help service providers authenticate their consumers in order to prevent fraud. With regard to these facts, centralized databases can have notable flaws as solutions to multiple-submission problems.

Centralized databases require adoption of their interfaces by many service providers. This makes them prone to many of the same difficulties as interface standards. Additionally, service consumers may be unwilling to trust the database service provider with their personal data unnecessarily. Even if users decide to trust a third-party database service provider, the database's computers become another point of vulnerability with respect to networked and physical access security. The present invention does not need to store user's personal data to be effective. Instead, it stores the associations formed by users between the fields on a standardized version of a form and fields on various vendors' web-sites.

One example of the centralized third-party database appears in the system described in Hitchcock, Michael D., Universal forms engine, U.S. Pat. No. 6,345,278, granted Feb. 5, 2002, in which students applying to several colleges may submit their application information to one central database which shares the data between each college's online application forms. Another example is Microsoft's Passport Network, which allows users to sign-in seamlessly to multiple websites, sharing the login information from the central “passport”. Both of these approaches are limited by the number of service providers that opt-in to participate in their centralized approach. Additionally, each participant is required to utilize a standard interface. The present invention provides a mean to share information across related applications without requiring an “opt-in” from the service provider or the acceptance of any interface standard.

D.3. User-Interface Extensions:

In Theory:

Web-site data entry has become common-place, and many internet users are familiar with entering certain articles of personal information, such as the user's name and email address into each of the web-sites that the internet user plans to visit frequently. Web-browser software can be extended to store frequently used personal data and recall it for automatic use when a web-site or its form-fields have certain features or when the user invokes the extension capability directly. With use, an extended browser can build up a database of information relevant to its user or users. An extension of a browser may include the capability to apply heuristic algorithms for identifying web-form features. A more comprehensive database of user information and more effective heuristics make such extensions more useful to users who desire to fill many web-forms with their personal data.

A central component of the present invention operates as just such a user-interface extension to a user's web browser. But the extension component does not need to apply heuristic algorithms to be effective. Instead, the extension only needs to identify features of form-fields that can identify the fields uniquely from among the other fields on its form. This is simple to accomplish automatically because of the nature of web-forms. (Uniquely identifying information is packaged, in a standardized way, in the HTML that describes a form field. This is because, when a web form is submitted, the data entered in its fields must be identified uniquely. In order for the web-browser to provide the data in a uniquely identified form, uniquely identifying features must be made available (to the web-browser) so it can prepare the submission appropriately.)

In Practice:

Form-filling web-browser extensions have been adopted by some of the internet's users. Extended browsers can guess many entries for many web-form fields. When the tools work, they can reduce the time taken to fill web-forms and increase the accuracy of data entered or reduce the time necessary to ensure that entered data is accurate.

The present invention allows the user to dynamically set values to be mapped to output fields. Further, the present invention does not require the source data to be present before use, and thus, the data used by the present invention is not vulnerable to security risks. Many existing form-fill systems fall prey to these vulnerabilities. Additionally, much of the prior art focuses on remembering individual user information that is often keyed in day after day, and would not be extensible to handle situations where, for example, a consumer is applying to a service provider on behalf of a client with their new information.

For example, Morse, Stephen P., System and method for automatically pre-setting form field values, U.S. Pat. No. 6,854,085, granted Feb. 8, 2005, describes a system that would automatically pre-set form fields with user information. In this system, field values are predetermined.

Another example is Light, John, Automatic web based form fill-in, U.S. Pat. No. 6,192,380, granted Feb. 20, 2001, which describes a system where a form in a web page is recognized and data is automatically filled into the form from a database. In this system, the source data is stored in a database, and, in a sense, must be predetermined.

Further demonstrating this trend is, Pennel, Mark, Method and apparatus for automatic form filling, U.S. Pat. No. 6,910,179, granted Jun. 21, 2005, which describes a system where a user-interface extension would “script” a user's action on a given web form and enable the script to replay on any future visits. Additionally, there is description of an ability to interact with a central database containing knowledge of multiple web forms, providing further functionality and ability to auto-fill. This system also stores user data in a database.

Some examples are only partly subject to these vulnerabilities, such as Sibert, Mark, Method and system for selecting a target window for automatic fill-in, U.S. Pat. No. 6,928,623, granted Aug. 9, 2005, which describes a system where a user can designate a window or windows to be automatically filled in with predetermined information, such as for the directing of digital wallet information. This system is not specifically a form-fill system, but to the extent that it interacts with digital wallet systems, it fails to offer the flexibility of the present invention.

Responding appropriately to features of web-forms is a very difficult problem. To handle all cases in general, the software would have to read a web-site as it would be rendered for human eyes and make the same assumptions about the expectations of various entry-fields that a human (who understood the context of the web-form) would. Currently, software that can match the general reasoning capacity of humans is not available. Instead, either much simpler rule-based systems or less predictably-reliable techniques from the field of artificial intelligence research are used to determine which form fields require the entry of certain data. These solutions cannot guarantee appropriate matches between source data and form fields.

Some examples in the prior-art attempt to use static rule-based systems, such as Philippe, Yan, Method and system for integrating transaction mechanisms over multiple internet sites, U.S. Pat. No. 6,882,981, granted Apr. 19, 2005, which describes a system where a user may select a number of items to purchase from a number of vendors, fill out one central check-out application, which in turn fills out the check out forms of the selected vendors. This system requires that ‘wrappers’ for target vendors be configured manually and stored in a database. No mechanism is provided such that the behavior of users automatically updates the wrapper.

Other methods attempt to rely on semantic matches between source and target field names, such as Breslau, Franklin Charles, Methods, systems and computer program products for copying between templates having associated field designations, U.S. Pat. No. 6,499,041, granted Dec. 24, 2002, which describes a system where a target template receives data from a source template when the fields match. The user is prompted to fill non-matching fields. But no explicit mappings and no mechanism to retain explicit mappings for future use are provided.

The performance of heuristic techniques must be evaluated on a form-by-form basis. In many cases these systems cannot fill all fields automatically. Because of this, users may be required to enter most of the fields manually. Occasionally, browsers extended in this way might fill a field with incorrect data. Because this may occur, users discover that they must review the entries generated automatically by their extended browser. The review process required of users in order to avoid incorrect and incomplete forms might reduce or eliminate the potential effectiveness of automatic form-fill browser extensions.

One example that employs methods from the field of artificial intelligence is Goodman, Joshua, Intelligent autofill, U.S. Pat. Application No. 20050257134, published Nov. 17, 2005, which describes a system where machine learning is used to correlate input data and form fields in order to provide a higher quality form fill solution. Aside from the need for a database of predetermined values, this system cannot reliably fill fields on new forms. This is partly because there are no known machine learning techniques that can make general guarantees of that type. Also, this is partly because some of the machine learning systems described are used with predetermined training. Such systems are unlikely to be useful on forms outside of their domain of training.

E. Objects and Advantages

None of the prior art provides a way to fully facilitate the submissions of applications to multiple service providers by service consumers. The present invention serves to meet this need. In so doing, it does not require that users store data in an independent database that may be confusing to manage or present a security risk. It does not require service providers to adopt a standard. Instead of applying techniques from the field of artificial intelligence, the invention gathers suggestions from its users, who posses actual intelligence, to build correlations between standardized source fields and these uniquely identifiable fields.

### BRIEF SUMMARY OF THE INVENTION

See the abstract accompanying this document for a high-level description of the present invention. For further explanation, the following ‘use case’ is presented:

A user desires to submit the same data to multiple entities. Each entity will accept the data when entered on a proprietary form and submitted. The user invokes the present invention to facilitate the filling of the multiple forms. The user enters the data, or indicates where it can be found in machine-readable form. The invention prompts the user to establish a link to each field on each form-to-be-submitted from an input datum for which an existing link is not already established or predetermined. The invention copies each datum as indicated by the links into the fields for submission. The user submits or causes the invention to submit each complete form to the appropriate entity.

### BRIEF DESCRIPTION OF THE SEVERAL VIEWS OF THE DRAWING

FIG. 1 illustrates the flow of the system as described in claim 1. Here, the output fields (1) require data for submission. The interactive field linker retrieves the list of output fields (2) in order to provide links to them. The input information (3) comprises fields and associated values. The interactive field linker retrieves this information (4) in order to provide link options. It is assumed that the user (5) desires to use input field values to fill output fields. The linker shows the output fields and available input fields and data (6) to the user. The user indicates which input field should be mapped to each output field (7). With these mappings, the linker causes the data-transfer-mechanism (8) to copy values from the appropriate input fields (9) to each output field (10).

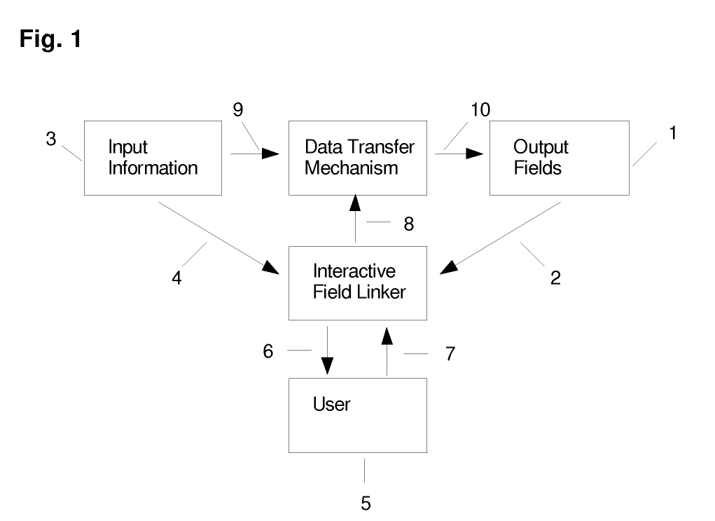

FIG. 2 illustrates the flow of the system as described in claim 2. Here, a ‘link-library’ has been added (1) that stores input-to-output field-to-field mappings. The library sends known mappings (2) to the data-transfer-mechanism so input information may be copied to output fields without the use of the interactive field linker. All output fields may not be filled, so the linker gets the known mappings (3) to help the user map input information to the remaining output fields. Created or modified mappings must be sent back to the library (4) for future use.

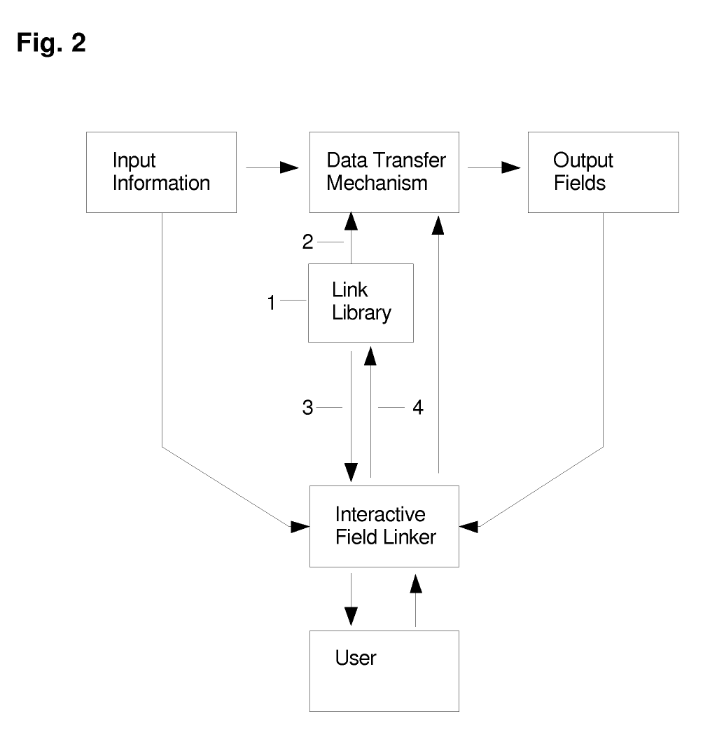

FIG. 3 illustrates the flow of the system as described in claim 4. Here, a selection mechanism (1) picks one mapping from any group that map to the same output field (contradictory group). The library sends known mappings (2) to the selection mechanism, and selected mappings are sent (3) to the data-transfer-mechanism to be applied. To help the user map to any unmapped output fields, the selected mappings are also sent (4) to the interactive field linker.

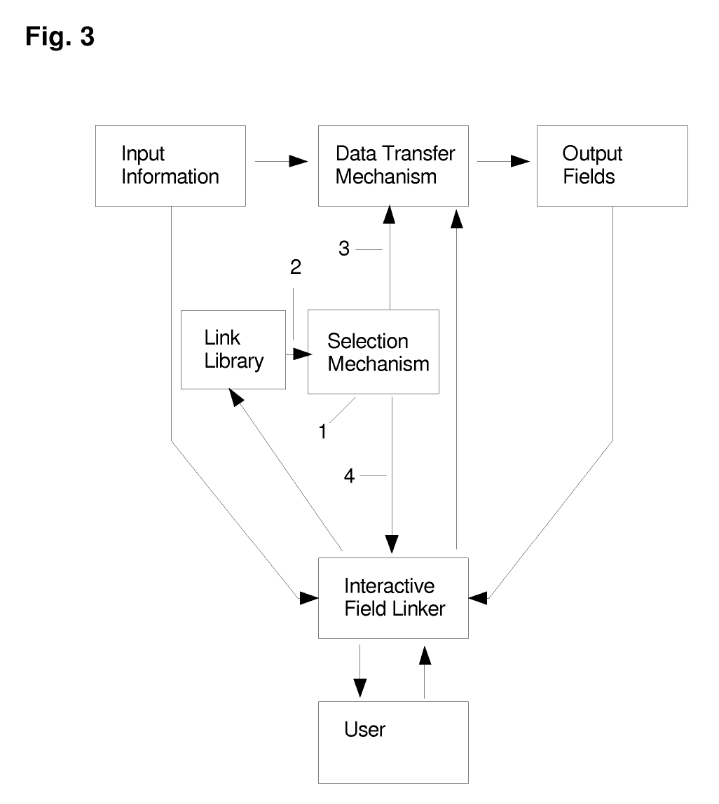

FIG. 4 illustrates the flow of the system as described in claim 7. Here, the elements of the form-fill system have been arranged to facilitate use by a wide community of users. The components necessary to apply the form-fill system are available to various users as multiple instances of the client-element. The components that retain and filter mapping information are available as the server-element to all instances of the client-element via the internet.

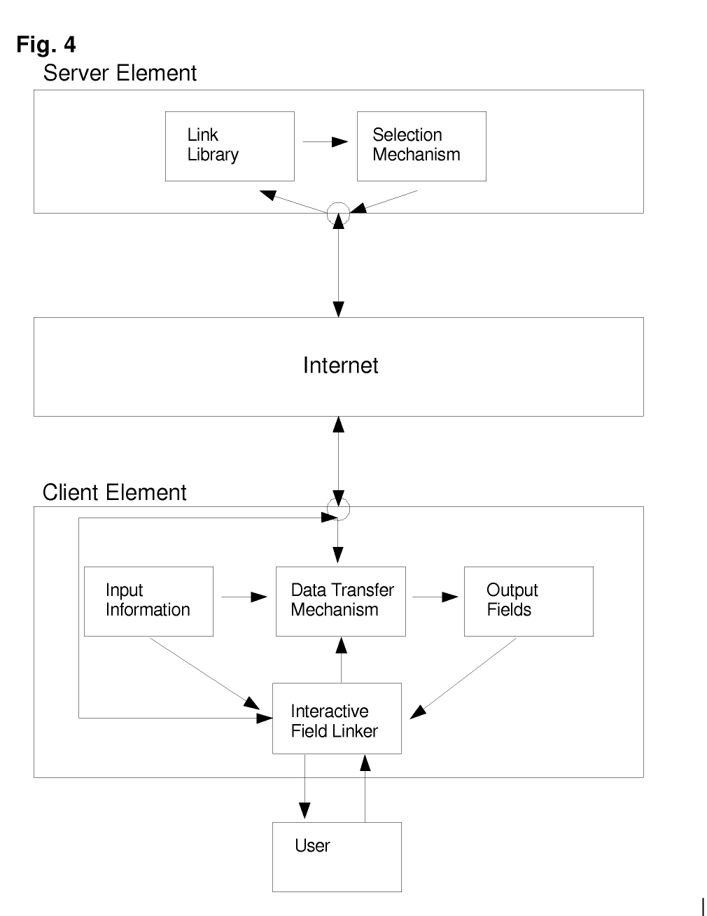

### DETAILED DESCRIPTION OF THE INVENTION

A. Notes on Terminology

Certain terms were selected to describe the present invention. These terms have conventional or common-sense meanings that are applicable in the context of the present invention. These choices were made to express the details of the invention as clearly as possible. To further facilitate reading of the following description, this section is provided as a reference for terms that may be unfamiliar or be used in ways that vary their scope from certain common-sense interpretations.

A.1. Form Fields

A form-field may be any field on any form for which computer automation could conceivably and meaningfully enter values. Some examples are web, electronic, software-application, and paper based forms.

A.1.a. Web Form Fields

These could be fields that appear on forms that are part of web-sites or otherwise described in HTML. In the context of the preferred embodiment, this is usually what is meant by ‘form-field’.

A.1.b. Electronic Form Fields

Electronic forms include web-forms and other standard document types like PDF. Electronic-form fields are fields that appear on forms of this type.

A.1.c. Software Application Form Fields

System applications may incorporate forms in their workflows. In an environment like Microsoft's Windows or X.org's XWindows, fields may be exposed to be filled. In these cases, inter-window messaging could allow other software running concurrently to automatically enter data. This could apply to applications that run from natively-compiled machine-code. Also, it could apply to applications that execute in an interpreted language or virtual machine. Examples include Sun Microsystem's Java or Microsoft's ‘.Net’.

A.1.d. Paper Form Fields

Where paper forms have been scanned and converted to machine-readable form by OCR (optical character recognition) technologies, the resulting forms contain fields that could be filled automatically. The forms filled in this way could be printed for submission in paper form or submitted electronically.

A.2. Field-to-Field Links

The links between form fields are referred to by several terms. Each of these terms refers to the same thing: the suggestion that a target field should receive data from either a particular source field or an explicitly-defined transformation on a collection of source fields. Some of the synonymous terms are mappings, correlations, associations, and links.

A.2.a. Mappings

This term highlights the fact that field-data is intended to be transferred from one field to another. In the context of the present invention, a complete map is one for which every target or output field is covered by a mapping from a source or input field.

A.2.b. Correlations

This term highlights the fact that field-to-field links carry certainty values when evaluated by one of the possible selection mechanisms. The certainty values are treated as if they were probabilities that their links apply to the target fields of their links. The certainty values answer the question, “How correlated are the linked source field and target field?”

A.2.c. Associations

This term focuses on the link itself. In some contexts, it is useful to discuss these links directly and refer to their existence and their properties.

A.2.d. Links

This term is short and the simplest conceptually. It can be useful when brevity of thought or word is important.

A.3. Contradictory Mappings

If mappings exist from multiple source fields to one target field, those mappings contradict one another. The reason for this is that, in the context of the present invention, only one mapping may be meaningfully applied to a given target field. Said another way: only one source field (or one explicitly-defined transformation on some number of source fields) may be written into a given target field.

A.4. Computer System

This term is used for its conventional meaning. Generally, a computer system comprises a CPU, memory, physical disks, network interfaces, user interfaces, an operating system, background service software, and user interface software.

A.5. Computer Component

A computer component or computer element is a vague term. It could apply to virtually any conceptually separable artifact of information automation. Examples might include: a particular piece of software stored or executing, a process or thread in an operating system, a CPU, a group of CPUs, a complete computer system, or a group of computer systems with some relationship to one another.

A.6. Heuristic

A heuristic is an algorithm that makes implicit assumptions in order to effectively reduce the complexity of the problem it is designed to solve. For this reason, heuristics do not guarantee the best solution to a problem. Instead, they select a solution that is likely to be better than many others.

Heuristics are often applied when mathematical reasoning demonstrates that a problem has no ‘closed-form’ solution or that a problem may only be solved by exhaustively searching all possible solutions. Many forms of machine learning (techniques from the field of artificial intelligence) may be considered heuristics.

B. Overview:

The present invention works by linking fields in a version of an application form that has been standardized for a given service or class of services to the fields on application forms used by providers of that service or of a service in that class. Said more simply, the present invention maps standard-form fields to provider-specific form fields.

The present invention builds this mapping by taking suggestions from its users. Users derive these suggestions by comparing a standardized version of a form with particular versions of the form offered by service providers. The standard form is a ‘universal’ interface that must be filled by a user so that the entered articles of information can be arranged appropriately on forms of providers and submitted for consideration. The providers involved in this process offer a service that the user is applying for and, typically, the particular providers selected are those the user is interested in applying to.

Embodiments of the present invention may use computer networks (for example: the internet) to collect field-to-field association data from many users into a global pool. Whenever a user attempts to use such an embodiment to fill a form, it can search its global pool for relevant association data to use in matching standard fields to the fields on the form in question.

B.1. The Standard Form:

Users of the present invention are presented with a standardized form for the service or class of services that the user has chosen to apply for. This form may represent the fields in a standard machine-to-machine interface published by a third-party. Alternatively, it may present fields that may be expected to appear on an application for the service the user is interested in. The specifics of these expectations could be obtained by various means, including cataloging forms viewed by users, incorporating user or service-provider suggestions, incorporating fields from published standards, or selecting fields that make reasonable sense in the context of the service in question.

B.2. The Provider Forms:

Users are also presented with the web application forms from the selected service providers. The present invention will automatically enter data from the standard form into each provider's form. To do this, the present invention will take available information regarding the association of standard fields with fields on each provider's application.

The present invention maintains a catalog of values, each of which may be regarded as the degree of certainty that a given source field maps to a given provider application field. Based on this certainty, the present invention will indicate to the user whether or not the user's attention is requested for a particular field. For associations with a high degree of certainty, the present invention enters the datum from the appropriate source field and does not call for user attention. In cases with low or intermediate certainties, the present invention can enter the appropriate datum into a field, but call for user attention in different ways based on the degree of uncertainty. If the present invention has no association (and thusly no certainty value) for a field, it can indicate to the user that no association is known.

Especially when the association is unknown, the present invention may additionally employ techniques employed by other form-fill mechanisms. For example, by analyzing features of the target field or the provider-form surrounding the field with heuristic methods, the present invention might choose a standard-form field to link from automatically. The extension would apply the guessed association and would indicate to the user that the filled data was the result of such a guess.

B.3. The User Interface:

At very least, the interface must allow the present invention to fill form fields; it must allow the user to indicate to the present invention which data from the standard form to enter into each provider form-field; and it must allow the present invention to indicate to the user which fields it can fill with certainty and which ones it cannot. For ease of use, an interface to the present invention system could be applied transparently over provider applications. This interface could highlight relevant fields, provide interactive field lists, and even suggest appropriate field associations by matching various data entered into fields on a provider's form with data entered into fields of the standardized input form.

C. The Preferred Embodiment:

In this section, ‘SEMCAT’ (for ‘Single Entry Multiple Carrier Assistance Tool’) will be used to refer to the present invention as an actual manifestation (as it is currently embodied).

SEMCAT comprises two major software components. These are an internet web-service and an extension module for a web-browser.

C.1 Web Service:

The web-service must supply the extension with association information and store updated association information that it receives from the extension. The web-service comprises several parts that allow it accomplish these tasks: a field association database and a mechanism for evaluating association certainty values. Also, the web-service is used to present a user-interface web-application to web-browsers running the extension.

C.1.a. Field Association Database

The web-service's primary role is to communicate with the web-browser extension about associations between standard fields and provider-form fields. Specifically, the web-service receives and stores field associations from browsers employing the SEMCAT extension module. Also, the web-service retrieves and transmits field association data to SEMCAT browsers in response to browser requests.

C.1.b. Certainty Values:

A set of rules dictates how information is retained for long-term storage in the association database. Different users may indicate to their SEMCAT extensions that different standard-form fields are associated with different provider-form fields. In order to derive a single field-association suggestion from, potentially, many contradictory suggestions, the web-service analyzes the submitted association history and applies a heuristic. This heuristic attempts to guess which field-to-field association is most likely the correct association and assign a likelihood to that guess.

Any implementation that can meaningfully reduce disparate suggestions to a single greatest-likelihood suggestion would be useful. The specific algorithm or heuristic used for this purpose is a configurable parameter within the existing implementation. Two possible algorithms are described below.

C.1.b.i Logistical Scaling Algorithm:

As implemented, this is the default selection algorithm.

How it works: SEMCAT remembers every suggested field-association. For this algorithm, SEMCAT keeps a certainty value for each suggestion. For a given target provider-form field, the collection of source standard-form field associations have certainty values that sum to unity (the numerical value ‘one’) or less. When a new association is suggested by a user, it receives a certainty value equal to half difference between unity and the current greatest certainty.

If adding this initial certainty would increase the sum of relevant certainty values above unity, the excess (over ‘one’) is recovered by deducting an equal amount from every other certainty value, the excess divided by the number other suggested associations. If no suggestions exist and thusly no certainty values exist, the greatest certainty value is assumed to be zero. In this case, the certainty value given to a suggested association is one-half, or half the difference between unity and zero.

When a user verifies a suggestion (by applying an existing suggestion to a new application process), that suggestion's certainty value is increased by half the difference between unity and the current greatest certainty. This is even the case if the verified suggestion possesses the current greatest certainty. Again, if the increase in certainty value would increase the sum of relevant certainties over unity, the excess is recovered by reducing each other certainty by an equal amount, the excess divided by the number of other certainties. If the certainty crosses a high-certainty threshold, additional user verifications are ignored. As implemented, this value is eight-tenths, or ‘0.8’.

General Effect: If a suggested association is already rated with ‘high-certainty’, a newly suggested association will receive a small certainty (approximately one-tenth). The certainties of the other associations will decrease slowly and will decrease more slowly when there exist larger numbers of other associations. As the largest association decreases, the newly suggested association will increase more rapidly. With continued verifications, the newly suggested association will eventually become the largest. At that point, it will increase less rapidly until it reaches the high-certainty threshold, where it ceases to increase.

C.1.b.ii. Proportional Scaling Algorithm:

This algorithm could be exchanged for logistic scaling very simply.

How it works: Again, SEMCAT remembers every suggested field-association. In this algorithm, SEMCAT keeps a certainty value for each suggestion. For a given target provider-form field, the collection of source standard-form field associations have certainty values that sum to unity or less. When a new association is suggested by a user, it receives a configurable default certainty value that rates in the low-to-intermediate range. If adding the default certainty value would increase the total sum above unity, the excess is recovered by reducing the certainty values of every other suggestion by an amount proportional to its certainty.

Whenever a user verifies a suggestion, that suggestion's certainty value is increased in order to halve the difference between its current certainty value and unity. Again, if the sum of certainty values for applicable suggestions would be increased beyond unity, the excess is removed (collectively from the remaining suggestion's certainties in proportion to their certainty value). When multiple suggestions that are determined to be the most certain have equal certainty values, the most recently suggested value is chosen as the most-likely suggestion.

General Effect: A new association always begins with the same predetermined certainty value. Each time the new association is verified (by use in subsequent form-fill events), it increases its certainty value by half the difference to unity. When existing suggestions that map to the same output field are reduced, larger certainty values receive a larger reduction. This allows new suggestions to overtake existing suggestions with a small number of verifications regardless of how many existing suggestions have already been cataloged.

C.1.c. User Interface Application

As implemented, the web-service also performs some secondary tasks that simplify the design of SEMCAT. When using SEMCAT, users are directed through a series of forms that allow users to manage their accounts, view statistics, and use SEMCAT to fill forms. These forms are generated by the web-service and communicated to browsers in much the same way as conventional web-forms. Users of SEMCAT can navigate these pages from their browsers much like conventional web-sites.

These forms, when displayed in a SEMCAT extended browser, compose an interface to many of the features of SEMCAT. This web application comprises several elements that facilitate using SEMCAT to fill forms. One element is a form that allows users to add or extend classes of service for which SEMCAT can fill application forms. Another selects the class of service for which to submit multiple applications. A subsequent form allows users to fill the standardized form associated with the selected service class. Also, the user will choose which service providers to submit an application to.

In principle, the capabilities exposed by these web-forms could be exposed by the browser extension without communication with the web-server. This would not change the application of SEMCAT in any substantive way. From one perspective, this change would be undesirable because, for certain classes of software changes, SEMCAT developers would have to apply the changes to all SEMCAT browser extensions by distributing an update to the community of users instead of making a change to the web-service only.

C.2. Extension:

The extension must interact with the users of SEMCAT, communicate with the web-service about field-to-field associations, and fill provider application forms with data from a user-filled standard form based on those associations.

C.2.a. User Interface:

To provide the user interface, the extension must override many default behaviors of the user's web browser. The extension must direct the browser to display the SEMCAT application. As implemented, the application is driven by web-forms hosted by the web-service component. The extension must cause the browser to connect to the web-service in order to display the web-forms that allow the user to manage account status, view statistics, and fill forms.

Also, the extension must hide or disable features of the web-browser that may increase the difficulty of navigating the application and of filling web forms. In this, the extension ‘takes over’ the browser. This results in a browser with a user experience that is centered around the features of SEMCAT and subsequently less useful as a general-purpose web-browser.

The extension must also make the features of SEMCAT available to the user while filling forms. The extension accomplishes this by placing user-interactive objects ‘over-top’ provider application forms. Specifically, the extension applies invocation buttons to form fields; indicates status of fields by manipulating their visual properties, and ‘watches’ the user enter data into provider-form fields in order to match the data with values from standard-form fields.

C.2.a.i. User-Invocation Button:

The extension places a button adjacent to each fillable field that allows the user to invoke SEMCAT as it applies to that field. As implemented, the button is labeled with an icon that indicates that it has been placed there by the SEMCAT extension. When clicked, the button opens a context menu under the pointing-device's location. The context menu allows the user to set and unset options that direct SEMCAT to behave in various ways regarding the field in question. The menu also presents a sub-menu that allows the user to choose a source standard-form field from which to copy a datum into the provider-form field in question.

C.2.a.ii. Status Indication:

The extension must visually operate on each field in order to indicate the status with respect to SEMCAT of each field to the user. This could be accomplished by overlaying icons or other imagery, or by manipulating the appearance of the adjacent SEMCAT-invocation button, or by changing the display properties of the field in question.

As implemented, the extension manipulates the display color of various features on each provider-form field to signal the SEMCAT status of each field to the user. The particulars of this manipulation are simple to vary, but one example might be illuminating the field: the background color of a field that SEMCAT does not recognize may be tinted red while the background color of a field that SEMCAT associates to a standard field with high certainty may be tinted green.

C.2.a.iii. Input-based Association:

The extension may register itself with the browser such that it is invoked automatically when the user types or enters values into form fields. To simplify the task of associating standard-form fields with provider-form fields, the extension performs this registration, and captures user-entries on provider-form fields. Then, the extension automatically pairs-down the list of available standard-form fields by matching whole or partial user-entries with data entered on the standard form. The extension displays this list of available standard-form fields in a drop-down box as an overlay adjacent to the provider-form field that the user is filling.

The entries in the box comprise a value entered on the standard form and the name of the field into which it is entered. As the user modifies the provider-form entry, the list continues to change to reflect an up-to-date selection of standard-form fields that could match the entered datum. This drop-down is interactive. The user may select an entry from the drop-down list at any point and the extension will finish filling the field to match the value from the standard-form and create (or modify) an association between the standard form and the provider-form's field. In this way, the SEMCAT extension ‘watches’ the user, and offers suggestions to help complete the mapping of standard-form fields to provider-form fields.

C.2.b. Web-Service Communication:

In order to provide each SEMCAT user with the benefit of the form associations created by the SEMCAT user community, the extension must connect to the web-service to retrieve associations that pertain to user's service provider choices. If the extension has access to more association information from its user, it must also connect to the web-service to update the information stored in the SEMCAT community's database.

C.2.b.i. Retrieve Correlations:

After a user has chosen a class of service to apply for and selected the providers that the user wants to submit applications to, the extension may connect to the web-service to retrieve any available standard-form field to provider-form field associations. The web-service may have never received correlations for the indicated providers. In this case, the web-service indicates to the extension that it does not posses any information regarding field associations. In its current implementation, the extension does not guess about field associations. (As discussed above, no automated guessing scheme, or heuristic, has been composed that reliably determines the expectation for articles of information entered into all form-fields in general.) Instead, the extension will call for the user's attention for each form field.

The web-service may have received field association data about every field that the extension detects on the provider's application form. The extension will be able to fill every field and, in certain cases, will not be required to call for user attention to fill fields or verify field data on the providers form.

The web-service may have received field association data about a subset of the fields on a provider's form. This may happen if the service of the provider has been extended or limited in some way, or if the application form has been modified by the provider for some other reason. In these cases, the extension will call the user's attention to the new and unrecognized fields. While entering new field associations, the user is free to review and correct existing field associations. The extension indicates the degree of certainty associated with fields that the extension recognized. The certainty indication can serve as a guide to a user who is reviewing the field associations for a given provider form.

C.2.b.ii. Update Correlations:

After a user has dealt with the various pages of a provider's application form, the user may have created or modified associations for the provider-form fields (using the interface presented by the extension). Or, more simply: when using SEMCAT, users will occasionally generate new field-to-field association information. When this happens, the extension connects to the web-service to notify it of the changes. The web-service applies its certainty-evaluation rules and stores the new information in its database.

C.3. Fill Provider-Application Web-Forms:

The extension's primary role is to automatically fill service-application web-forms. To do this, the extension loads the web-forms of service providers and retrieves known field associations from the web-service. Then, for each provider-form field for which the extension can find a known field-association, it applies the association by copying a datum from the standard form.

The standard form is filled by the user within the extension. Because the form data is available from within the extension, the field-to-field copy does not require that the data be stored externally or move over the network. In some cases, this is a significant advantage because such storage or movement may be regarded as a security risk.

C.3.a. Loading Web-Forms:

In order to initiate a particular form-fill process, the extension must have the initial URL for each provider-form it will attempt to fill. As implemented, these URLs are loaded (from the web-service) with the list of available service providers when the user chooses a class of service (for which to submit service applications). For each provider selected by the user, the extension opens a new graphical browser-display-space and causes the browser to load the URL there. In its current implementation, these new display-spaces are browser tabs.

(Browser tabs are available in several modern web-browsers. For an example, see the ‘Firefox’ web-browser by the Mozilla organization at ‘http://www.mozilla.com/firefox/’. Firefox's license allows it to be freely or commercially distributed in executable or source-code form. This is one reason why Firefox was chosen as the particular browser to extend to enable the current implementation of SEMCAT.)

C.3.b. Applying Associations:

After selecting the class of service to apply for, the user selects which providers to submit an application to. Then the extension can connect to the web-service to retrieve field-to-field associations for each selected provider. The association retrieval and the web-form loading both take place when the user has filled the standard form and indicated that the user is ready to begin submitting applications to multiple providers.

Once each web-form is loaded and its field associations have been retrieved, the extension applies the associations. To do this, the extension finds an association for each provider-form field that indicates the provider-form field as its target. For each association identified in this way, the extension reads the value from the standard-form field indicated by the association's source. Then the extension writes the value into the provider-form field. Said more simply: the extension copies standard-form values into provider-form fields based on available associations.

Writing values into provider-form fields may not be a straightforward task. Sometimes, these fields are simply text-areas that accept expressions of virtually any kind. Other times, the fields may only accept inputs from a small discrete set. Conventional check-boxes, ‘radio-buttons’, and drop-downs (or selection-boxes) are of this type. While these fields may still be identified uniquely, there must be other techniques for handling the mapping of standard-form field-values into them.

C.3.b.i. Value Transformations:

In order to reliably map values to form-inputs that only accept discrete values, a mapping may contain macro statements that tell the extension how to compress the source value to one that the discrete input might accept. The extension contains a configurable macro engine that applies these macros when copying values into target form-fields.

Example macros include a truncation macro with a length parameter that indicates to the extension to take characters from the beginning of the source string up-to the value of the length parameter. Another practical macro is one that automatically converts the name of a United States state into its postal abbreviation if the abbreviation values are available as options within the discrete input.

Virtually any transformation or combination of transformations imaginable can be configured into the transformation engine. It also supports concatenating the values of source fields or the results of transformations. This can be useful when a target field requires the entry of a value composed of multiple source-field values. A transformation can be configured into the engine to first appropriately transform each source-field value then compose a final value by placing them together in one string.

The transformation engine also allows the extension to more easily fill other kinds of discrete-value inputs. A special macro exists that invokes the user-generated association idea in a narrower context. If no rule-based method for converting source values to discrete-input values can be found, then this macro builds associations between source values and the elements of a discrete input. With use, the macro associates many or all possible source values with desired elements in a target discrete-input.

C.3.b.ii. Discrete-Input Handlers:

Check-Boxes: To map values to check-boxes, the extension must reduce the source value to a simple ‘checked’ or ‘unchecked’ state. To do this, the extension is equipped with a configurable engine for mapping source values of various kinds to a check-box state. Most of the rules for this engine are obvious. For example, ‘yes’, ‘on’, ‘true’, and ‘1’ are mapped to the ‘checked’ state; while ‘no’, ‘off’, ‘false’, and ‘0’ are mapped to the ‘unchecked’ state.

Drop-Downs: Each selectable element in a drop-down has both a display-value and a hidden machine-value. This additional complication means that the extension must read and catalog both sets of possible values before applying transformations to the associated source-field values. With both lists, transformations that depend on the available values can be performed. Then, a final transformed source value can be determined. The extension then attempts to match the final value against the list of display-values and the list of machine-values. If a match is found, the field association is applied by selecting the drop-down element with the matching value.

Radio-Buttons: Radio-Buttons are particularly difficult to handle because the intended meanings of possible radio-button selections are defined in the surrounding HTML. By default, the extension looks for text immediately adjacent to each radio-button. If text is found, it is taken to be the display-value of that particular radio-button selection. Then, applying correlations works as it does with drop-downs.

Often, the machine-value of radio-buttons is not useful for matching to source values. It is also possible that meaningful explanatory text is not found adjacent to the radio-buttons or text that is found is not useful as a display-value. In these cases, the transformation engine can be invoked and the special user-association macro can be applied. Radio-buttons usually posses a small number of selectable options. This is because it quickly becomes impractical to arrange many radio-button options on a web-form. Because the number of options tends to be limited, the user-association should account for all possible options after a relatively small number of uses.

What is claimed is:

1. A method for filling form-fields comprising:
(a) input means for receiving contents of form-fields
(b) output means for placing contents into form-fields
(c) interactive means for allowing users to indicate which fields from said input means map to fields of said output means
(d) and transfer means by which contents from said input means are copied to fields with said output means according to mappings like those produced by said interactive means
whereby users can fill a plurality of forms from a plurality of data using a plurality of predetermined mappings or a plurality of mappings indicated by said interactive means.

2. The method of claim 1 further comprising a library means for retaining a plurality of mappings of the type produced by said interactive means comprising:
(a) storage means for recording said plurality of mappings such that said mappings may be recovered
(b) and retrieval means for recovering a subset of said mappings from stored recordings
such that said mappings are made available as if they were a subset of the plurality of predetermined mappings for subsequent use of the form-fill method whereby the method reduces the frequency with which users are required to use said interactive means to completely specify a form-mapping set by:
(c) building-up a catalog of the input-to-output mappings in said library means by use of said interactive means
(d) and subsequently applying said mappings by use of said transfer means.

3. The method of claim 2 such that said mappings are made available to systems with access to a recording medium of said storage and said retrieval means whereby said mappings could be used in other contexts such as statistical analysis of form and field relationships.

4. The method of claim 2 further comprising a selection means for choosing an appropriate input-to-output mapping from a plurality of contradictory mappings comprising:
(a) search means for finding said plurality of contradictory mappings among said plurality of mappings in said library means
(b) decision means for choosing said appropriate mapping from said contradictory mappings such that said appropriate mapping is likely in many situations to cause said transfer means to correctly assign field-contents from said input means to fields through said output means
whereby said selection means allows said transfer means to operate usefully when a plurality of users have indicated said contradictory mappings with said interactive means.

5. The method of claim 4 such that said selection means evaluates relevant statistics regarding said mappings in order to determine a certainty that said appropriate input-to-output mapping is the correct choice whereby said selection means may compare said certainty values in order to choose said appropriate mapping and the user may consider said certainty values when evaluating mappings that have been applied automatically.

6. The method of claim 4 further comprising network means for sharing information over interconnects among greater-than one isolated element, each comprising a plurality of sub-elements where each sub-element of each said plurality of sub-elements is selected from the group comprising:
(a) said input means
(b) said output means
(c) said interactive means
(d) said transfer means
(e) said library means
(f) and said selection means
such that each said isolated element uses information provided by said network means in order to perform its tasks whereby various combinations of processes of the form-fill method that are isolated except for through said interconnects are allowed to function by said network means.

7. The method of claim 6 such that:
(a) each sub-element selected from the group consisting of:
(i) said input means
(ii) said output means
(iii) said interactive means
(iv) said transfer means
(v) said library means
(vi) and said selection means composes a separate element
(b) each said separate element operates as its own process in a multi-processing operating system on a single computer system
(c) each process in said multi-process operating system may be connected to others via a plurality of shared-memory segments
(d) and said network means operates by transferring information through said plurality of shared-memory segments
whereby the efficiency with which said method uses computer resources may be increased by using the multi-processing capabilities of said multi-processing operating system.

8. The method of claim 6 such that
(a) said library means and said selection means compose a server element
(b) said input means, said output means, said interactive means, and said transfer means compose a client element
and said server element and said client element are connected over the internet and said network means allows said server element and said client element to exchange said mappings whereby multiple instances of said client element may share said mappings (stored and managed by said server element, running decentralized or on a single computer) worldwide due to the internet's ubiquitous nature.

9. The method of claim 8 such that the functions of each instance of said client element are carried out by a software application running on a single computer system where each computer system has access to the internet whereby said software application can be easily distributed and installed on the computer systems of potential users.

10. The method of claim 9 such that said software application comprises:
(a) an extensible general-purpose web-browser
(b) an extension for said web-browser
such that said web-browser extended by said extension may carry out the functions of said client element to fill a plurality of web-forms accessible to said browser whereby the difficulty of filling web-forms is reduced by applying said method and an implementation of said method may utilize the features of said web-browser to reduce the complexity of said implementation.

11. The method of claim 10 such that:
(a) said general-purpose web-browser may display web-pages in a plurality of tabs (or the browser supports tabbed browsing)
(b) and said extension utilizes said plurality of tabs to display pages of a plurality of web-forms
whereby pages of each web-form relevant to a user during use of said method may be displayed in a coherent group.

12. The method of claim 11 such that said interactive means is overlaid with each of said plurality of web-forms such that a plurality of functions of said interactive means are available through features of each of said plurality of web-forms whereby users may use visual elements added to each of said plurality of web-forms to invoke said interactive means directly as said interactive means may apply to fields on each of said plurality of web-forms.

13. The method of claim 12 such that certainty values that may be produced by said selection means are represented as colors overlaid on fields that are targets of each said appropriate mapping chosen by said selection means whereby said colors may help users direct their attention to mappings that are less likely to be appropriate.

14. The method of claim 12 such that pop-up context menus are available that allow the user to edit and create mappings to fields using a means selected from a group consisting of
(a) menus that pop-up when a user clicks a particular mouse button within a field
(b) and buttons placed adjacent to fields that cause a pop-up to display when clicked whereby users may directly edit and create mappings by selecting source fields or field values from a list.

15. The method of claim 12 such that, as a value is entered into a field, a pop-up menu appears that is populated with possible source mappings selected by comparing the entered portion of a value to values available in source fields whereby users may edit and create mappings while filling target forms and users may more easily select the appropriate mapping by entering a portion of or all of a value from a source field into a target field.

16. The method of claim 11 such that:
(a) said plurality of web-forms are each applications for services
(b) and a plurality of predetermined standardized versions of said applications are used as said input means
whereby applications for a plurality of similar services may be filled by filling one application form when form fields on applications for said plurality of similar services may be anticipated.

17. The method of claim 16 such that said predetermined standardized versions of said applications are derived from industry standard forms published by an applicable service industry whereby a plurality of fields of said predetermined standardized versions of said applications are specified by a credible third-party in order to encourage wide-spread adoption of said plurality of fields among service providers.

18. The method of claim 16 such that said plurality of web-forms are made available by service providers in the insurance industry whereby a plurality of commercial and personal insurance coverage applications may be submitted by filling only one form.

19. The method of claim 8 such that the functions of said server element are carried out by a plurality of computer systems where each computer system of said plurality of computer system has access to the internet and each member of said plurality of computer systems communicate among themselves to consistently perform said functions and consistently provide said mappings to instances of said client element and receive new mappings from instances of said client element whereby a single computer system or a cluster of computer systems can be used to manage and provide said library means and said selection means for a plurality of instances of said client element.

20. The method of claim 19 such that said storage and said retrieval means are provided by relational database software running on said plurality of computer systems whereby mapping data are managed in an efficiently searchable manner by a software suite maintained by developers other than those who are responsible for said method thus simplifying implementation and use of said library means.

21. The method of claim 19 such that said network means comprises HTTP-based web-services such that instances of said client element may interact with said server element using said web-services whereby an existing protocol may be used for which automation tools are freely available.
